(19) United States
(12) Patent Application Publication
(10) Pub. No.: US 2025/0217911 A1
(43) Pub. Date: Jul. 3, 2025

(54) VALIDATION OF NOVELTY WITH ARTIFICIAL INTELLIGENCE AND HEURISTICS

(71) Applicant: International Business Machines Corporation, Armonk, NY (US)

(72) Inventors: Sanket Jain, Gurgaon (IN); Ayaskanta Panigrahi, Bhadrak (IN); Ratnakar Behera, Bangalore (IN); EMINE NART, Dublin (IE)

(21) Appl. No.: 18/402,978

(22) Filed: Jan. 3, 2024

(51) Int. Cl. G06Q 50/18; G06F 16/2457

(52) U.S. Cl. CPC G06Q 50/184; G06F 16/24578

(57) ABSTRACT

According to one embodiment, a method, computer system, and computer program product for checking the novelty of an invention is provided. The embodiment may include identifying information describing an invention. The embodiment may also include defining a search space of prior art. The embodiment may further include refining the search space based on a comparison between the invention and the prior art using natural language processing, and further based on a heuristic algorithm. The embodiment may also include determining a rating of a reference found in the refined search space. The embodiment may further include assessing a novelty of the invention based on the rating.

### BACKGROUND

The present invention relates generally to the field of computing, and more particularly to search and optimization.

Search and optimization algorithms are a class of algorithms used to identify useful portions of data from a larger set of data. Search and optimization algorithms may take advantage of graph theory, data comparison, heuristic techniques, and various other methods for identifying, indexing, sorting, narrowing, modeling, or rating data points and data sets. Search techniques may be crucial in facilitating efficient analysis of complex data, whether by a human or a different algorithm.

### SUMMARY

According to one embodiment, a method, computer system, and computer program product for checking the novelty of an invention is provided. The embodiment may include identifying information describing an invention. The embodiment may also include defining a search space of prior art. The embodiment may further include refining the search space based on a comparison between the invention and the prior art using natural language processing, and further based on a heuristic algorithm. The embodiment may also include determining a rating of a reference found in the refined search space. The embodiment may further include assessing a novelty of the invention based on the rating.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for a process for assessing novelty using various techniques.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to search and optimization. The following described exemplary embodiments provide a system, method, and program product to, among other things, check an invention's novelty by searching for and identifying relevant prior art. Therefore, the present embodiment has the capacity to improve the technical field of search and optimization by providing a method to narrow a search space for complex data structures through a combination of artificial intelligence (“AI”) and heuristic techniques.

As previously described, search and optimization algorithms are a class of algorithms used to identify useful portions of data from a larger set of data. Search and optimization algorithms may take advantage of graph theory, data comparison, heuristic techniques, and various other methods for identifying, indexing, sorting, narrowing, modeling, or rating data points and data sets. Search techniques may be crucial in facilitating efficient analysis of complex data, whether by a human or a different algorithm.

Inventions are complex concepts that cannot easily be reduced to data. Further, any worthwhile representation of an invention for search purposes would necessarily be highly complex, and therefore, difficult to use as a typical search term or compare with typical search results in an effective way. As such, it may be advantageous to combine natural language processing techniques (“NLP”) like topic modeling and large language models with heuristic methods like particle search optimization to define, narrow, and rank results within a search space of prior art in order to reliably assess novelty.

According to one embodiment, a novelty checking program identifies information describing an invention. The novelty checking program then defines a search space of prior art. The novelty checking program then narrows and refines the search space using both NLP comparison techniques and heuristic algorithms. The novelty checking program then rates matches in the prior art. The novelty checking program then assesses the novelty of the invention based on the relevant prior art.

This method may have the advantage of allowing the novelty checking program to search a search space that may be orders of magnitude larger, or search according to more minute details or more complex interpretations, allowing for a wider search, more meaningful and accurate. The method may also have the advantage of significantly increasing speed and reducing cost of searches, particularly repeated searches with small modifications, creating opportunities for new utility.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

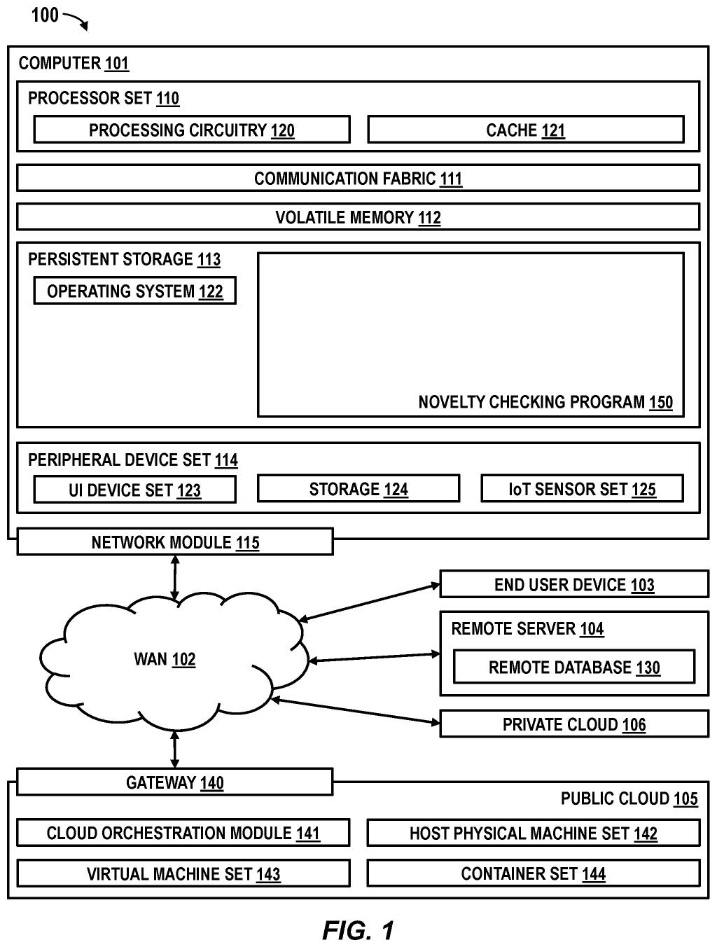

Referring now to FIG. 1, computing environment 100 contains an example of an environment for the execution of at least some of the computer code involved in performing the inventive methods, such as novelty checking program 150. In addition to novelty checking program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and novelty checking program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in novelty checking program 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in novelty checking program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth® (Bluetooth and all Bluetooth-based trademarks and logos are trademarks or registered trademarks of the Bluetooth Special Interest Group and/or its affiliates) connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The novelty checking program 150 may identify information describing an invention. The novelty checking program 150 may then define a search space of prior art. The novelty checking program 150 may then narrow the search space by comparing the invention to the prior art using NLP techniques. The novelty checking program 150 may further narrow the search space use of heuristic algorithms such as Particle Search Optimization or other stochastic algorithms. The novelty checking program 150 may then rate or rank prior art found through the narrowed search. The novelty checking program 150 may then use the rated or ranked prior art to assess novelty.

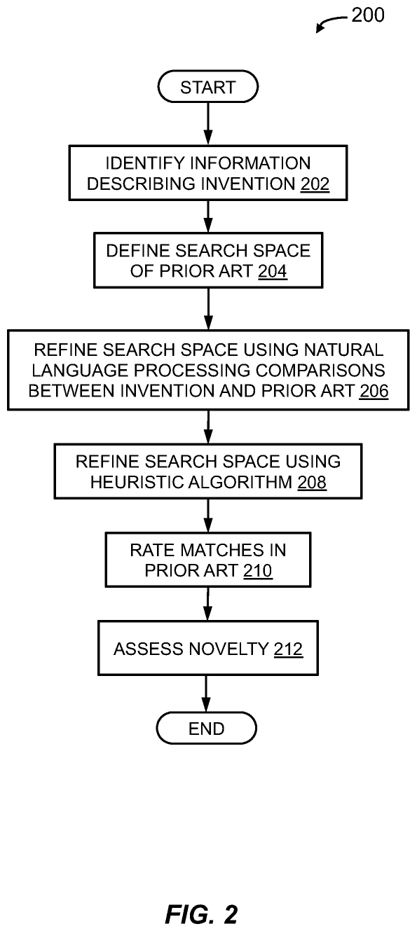

Furthermore, notwithstanding depiction in computer 101, novelty checking program 150 may be stored in and/or executed by, individually or in any combination, end user device 103, remote server 104, public cloud 105, and private cloud 106. The data management method is explained in more detail below with respect to FIG. 2.

Referring now to FIG. 2, an operational flowchart for a process for assessing novelty using various techniques 200 is depicted according to at least one embodiment. At 202, the novelty checking program 150 identifies information describing an invention. Information (which may also be referred to as data) may be identified from invention documents; collaboration services such as chat services; a patent, patent application, or patent draft; an inventor's notes; or any other source of data that may describe an invention. Information may be identified using a variety of methods, including NLP techniques such as topic modeling, speech to text, named entity recognition, and large language models. Any information collected at this or any point that relates to a user may be collected using opt-in procedures. Identifying data may, in general, include generating data or translating data into new formats or languages.

Information describing an invention may be identified from various sources, including, for example, invention documents; collaboration services such as chat services; a patent, patent application, or patent draft; an inventor's notes; any other source of data that may describe an invention; or any combination of those sources. These sources may exist in natural language formats, visual formats such as figures and drawings, structured data formats, any other format used for describing an invention, or any combination of those formats.

Invention documents may include, for example, a written document, presentation, set of notes, patent, patent application, or patent draft prepared by an inventor, patent practitioner, or other invention professional. Invention documents may include, for example, titles, written sections, section headers or slide headers, figures such as charts and drawings, lists of key features or potential claims, a listing of already known prior art references with statements differentiating the reference from that prior art, or any other forms of data with varying degrees of structure. Information may further include metadata about the invention documents, such as one or more authors of the document, the locations of the authors, or a time when the document was created or modified.

Collaboration services may include, for example, text-based chat services, audio and video conferencing services, shared document editing services, and whiteboard-type services, such as Mural® (Mural and all Mural-based trademarks and logos are trademarks or registered trademarks of Tactivos, Inc. and/or its affiliates). A collaboration service may facilitate collaboration through multiple media, such as a text-based chat service with a voice calling feature and a screen sharing feature. Collaboration services may identify the content shared through the services, such as messages in a text-based chat or charts drawn in a whiteboard-type service, and metadata such as authors of various pieces of content, their titles, or the times and order of various messages, comments, or edits. Information may be identified from a collaboration service automatically, or in response to an event, such as a request directing the novelty checking program 150 to scan a piece of collaborative content such as a chat room or collaborative document for potential inventions.

Information may be identified using a variety of methods, including NLP techniques such as topic modeling, speech to text, named entity recognition, and large language models; simple text analysis methods such as parsing by regular expressions; visual analysis of visual data such as drawings or figures; or simpler parsing of structured data from a structured data source. NLP techniques, including topic modeling, speech to text, named entity recognition, and large language models, as well as other techniques, may include a process of AI, machine learning, and use of trained machine learning models. The novelty checking program 150 may collect feedback or otherwise train a machine learning model at any point in the process for assessing novelty using various techniques 200, or use a model trained by another process.

In a preferred embodiment, information may be identified using topic modeling. Topic modeling may be used to identify one or more topics reflected by the invention, which may in turn be used, in particular, to help define a search space at 204. Topics may include “subtopics,” or various levels of more general and more narrow topics. An invention may have multiple topics, including two different topics that describe the whole invention, or two different topics that describe two different key elements or claims of the invention.

In further embodiments, information may be identified through other NLP techniques, including speech to text, named entity recognition, and large language models. For example, speech to text may be used to create a text representation of an audio conversation, and large language models may be trained on various invention documents and used to generate a simulated abstract describing the invention from the text representation of the audio conversation.

Information may further, still, be identified using other techniques, such as simplified text processing methods such as regular expressions; visual analysis or image processing methods such as text recognition; simplified parsing of structured data; or any other method, including any other use of AI or machine learning.

The novelty checking program 150 may identify (including by generating) a sample of, a title, abstract, claim or claim set, problem statement, specification, or drawings for invention as may facilitate a search.

Information may be identified from a variety of sources, in a variety of formats, or according to a variety of methods. Identifying information may include identifying correlations between information from multiple different sources or formats or methods. For example, if inventors are identified from an invention document, the novelty checking program 150 may scan a collaboration program for collaborative efforts involving two or more of the inventors, and use topic modeling to match relevant information.

Information may be identified or modified at any time in the process for assessing novelty using various techniques 200. Identifying new information or modifying information may result in a new search, a modification of an existing search, a re-rating at 210, or a re-assessment at 212.

Then, at 204, the novelty checking program 150 defines a search space of prior art. Prior art may include prior art references such as foreign or domestic patents or patent applications, technical or other writings, product descriptions or advertisements, or any other reference that may be treated as prior art. The search space may be a large set of prior art references that may be generally relevant to the invention. Defining a search space may further include mapping, structuring, or otherwise describing the space beyond a mere listing of items.

In at least one embodiment, prior art may include prior art references such as foreign or domestic patents or patent applications, technical or other writings, product descriptions or advertisements, or any other reference that may be treated as prior art. For example, prior art may include references from one or more national databases of patents and patent applications; a series of academic journals, technical publications, or any other publications or sections of publications; a repository of technical websites, product advertisements, or other product descriptions; or any other source of data that may contain relevant references.

The search space may initially be defined as a large set of prior art references that may be generally relevant to the invention. The initial search space may comprise all of the prior art identified above, or a selection defined more narrowly by topic modeling or by a preliminary search such as a simple keyword search. More specifically, a search space may be defined, for example, as all references in database sections with topics matching a topic selected by topic modeling at 202; all references whose titles include a key word or phrase identified at 202; all references from authors or inventors known to be active in a field of the invention; or any space combined by any combination of these criteria. A search space may further be defined to include only part of a particular reference, such as only certain chapters in a book. Once defined, the search space may be further refined or narrowed at 206 and 208.

Defining a search space may further include mapping, structuring, or otherwise describing the space beyond a mere listing of items. Describing the space may be performed using statistical modeling, AI, or any other technique. As more specific examples, describing the space may be performed using topic modeling of references, Gaussian mixture models, or Latent Dirichlet Allocation. Gaussian mixture models may be used, for example, as a clustering mechanism. Defining a search space may include formatting a search space to facilitate refining via natural language processing at 206 or a heuristic algorithm at 208. For example, defining a search space may include determining a mapping of the search space for particle swarm optimization at 208.

Defining a search space may include determinations based on any of the information identified at 202, or on any similar information in any prior art, or title, tag, abstract, or other description describing any prior art, or describing any database, publication, section, or repository from which the prior art is obtained.

Further still, defining a search space may include assigning a preliminary rating or ranking to one or more pieces of prior art. A preliminary rating may be a standardized baseline, such as 0 for each piece of prior art, or a rating defined by any of the methods.

A search space may be redefined or modified at any point during the process for assessing novelty using various techniques 200. For example, if, after reviewing 500 articles from a newspaper's technology section, no relevant articles are found through steps 206 and 208, the remaining references from the newspaper may be removed from the search space. As another example, the novelty checking program 150 may identify new publications that hold relevant prior art, or translate new references to add to the search space over time.

Next, at 206, the novelty checking program 150 refines the search space by comparing the invention to the prior art using NLP techniques. Refining the search space may include, for example, narrowing the search space, modifying the search space, or modifying metadata of references, including a preliminary rating or ranking of references. NLP techniques may include any of the methods described above or any other NLP technique. Comparing may include identifying a rating or threshold measure of similarity, identifying a matched limitation,

Refining the search space may include narrowing the search space by removing irrelevant references, modifying their metadata to remove them in practice, or marking an element or limitation the references are thought to cover as not covered. Narrowing a search space, particularly by removing irrelevant references, may incrementally improve performance of the novelty checking program 150. References may be removed individually or collectively, such as by removing a set of references thought to be irrelevant such as all unchecked references from a publication that has shown a high proportion of irrelevant references so far.

Refining the search space may further include modifying the search space, such as by redefining a search space to find more references, to remove categories or references now thought to be irrelevant, or modifying a mapping, structure, or description of the references, such as by re-clustering references or modifying a mapping for particle swarm optimization at 208.

In other embodiments, refining the search space may include modifying metadata of references, such as a preliminary rating or ranking of references, summaries generated for the references by text-generating algorithm at 204, or an indexing of each reference to simplify future search regarding that reference.

NLP techniques may include any of the methods described above or any other NLP technique. NLP techniques may include AI and non-AI methods, including use of a trained machine learning model, including a large language model. Specific techniques may include parsing, topic modeling, speech to text, named entity recognition, statistical modeling, artificial neural networks, word-sense disambiguation, relationship extraction, and semantic role labeling. For example, NLP with word-sense disambiguation may be used when comparing the invention and a prior art reference to identify a distinction between the invention and the reference, and the novelty checking program 150 may, then, reduce a temporary, preliminary, or intermediate rating of the reference to signify that it is less likely to be a match.

Comparisons may use NLP on the invention side of the comparison, the prior art side, or both, and may use the same method or two different methods on either side, or may use an NLP method that applies to the comparison itself rather than either side. For example, one comparison may use NLP to identify a list of keywords in the invention and search each piece of prior art with a simple keyword search to see what proportion of keywords on the list of keywords are matched in the prior art; may conduct the same comparison but with word-sense disambiguation and named entity recognition by a trained machine learning model used to facilitate the comparison. Alternatively, if a prior art reference is a video of a technical conference with audio, a transcript describing the invention identified at 202 by speech-to-text may be compared to a transcript of the prior art reference generated by speech-to-text.

Refining the search space at 206 and 208 may occur in any order; simultaneously, in parallel; alternatively; repetitively, for example until a certain overall threshold number of prior art references or threshold confidence rate in the results is met; or on any other cadence. Refining at 206 and refining at 208 may be similar processes except for the use of NLP at 206 and the use of heuristic techniques at 208. Refining at 206 and refining at 208 may recur at any point during the process for assessing novelty using various techniques 200. For example, upon a finding that an invention is not novel at 212, inventors may discuss the novelty of the invention on a collaboration platform and further distinguish the invention from the prior art in their discussion, triggering modification in information at 202, leading to a change in the search space at 204, and providing a modified search space to refine at 206 and 208, along with useful feedback about the operation of the novelty checking program 150.

Then, at 208, the novelty checking program 150 refines the search space using one or more heuristic algorithms. Heuristic algorithms may include Particle Swarm Optimization or other stochastic algorithms. Refining the search space at 208 may be performed in the same way as refining the search space at 206.

Heuristic algorithms may include metaheuristic algorithms, stochastic optimization algorithms, evolutionary algorithms, and more specifically including particle swarm optimization, genetic algorithms, rider optimization algorithms, variable neighborhood search, or any other heuristic algorithm that may be useful for refining the search space.

In a preferred embodiment, a heuristic algorithm may include particle swarm optimization (which may also be referred to as swarm particle intelligence) may include a set of known metaheuristic or stochastic optimization techniques with multiple candidates. Particle swarm optimization algorithms may be used, for example, to identify locally optimal matches in the search space, where each local maximum represents a prior art reference that is highly likely to be relevant to the invention's novelty.

An optimization function may optimize for the relevance of a prior art reference to the invention generally, or for other questions regarding the invention's novelty, business value, or any other factor to be assessed at 212.

In further embodiments, the novelty checking program 150 may use more than one heuristic algorithm, either one after the other, together, in parallel, or in any other combination.

Aside from the underlying methods involving NLP or stochastic algorithms, refining the search space at 208 may be performed in the same way as refining the search space at 206, including, for example, narrowing the search space, modifying the search space, or modifying metadata of references.

Again, refining the search space at 206 and 208 may occur in any order; simultaneously, in parallel; alternatively; repetitively, for example until a certain overall threshold number of prior art references or threshold confidence rate in the results is met; or on any other cadence. Refining at 206 and refining at 208 may be similar processes except for the use of NLP at 206 and the use of heuristic techniques at 208. Refining at 206 and refining at 208 may recur at any point during the process for assessing novelty using various techniques 200. For example, upon failing to assign confident ratings at 210, the novelty checking program 150 may engage in an extra round of refining the search space by the methods at 206, 208, or both.

Then, at 210, the novelty checking program 150 rates a prior art reference in the refined search space. A rating may represent the relevance of a prior art reference to the invention generally, the invention's novelty, the invention's business value, or any other factor to be assessed at 212. Rating may be performed based on temporary, preliminary, or intermediate ratings at 206 or 208, or using any NLP, AI, or heuristic method described above. Rating may include determining abstract scores, concrete ratings such as a percentage likelihood that the prior art is relevant, or rankings of prior art.

A rating may represent the relevance of a prior art reference to the invention generally, the invention's novelty, the invention's business value, or any other factor to be assessed at 212. For example, a rating may represent a percentage likelihood that an invention is novel given the reference, or a number of features of the invention that distinguish the invention from the reference.

Rating may be performed based on temporary, preliminary, or intermediate ratings at 206 or 208, by a simple calculation like a ratio of keywords matched, or using any NLP, AI, or heuristic method described above. For example, a rating may be set to equal the final rating found through preliminary and intermediate rating decisions made during the refining at 206 and 208. Alternatively, ratings may be determined independently, as a separate step based, for example, on a variety of NLP and AI methods given the refined search space. As a more specific example, ratings may be determined for each piece of prior art in the refined search space by an artificial neural network, where the artificial neural network is trained by invention professionals who enter ratings for various pieces of prior art for various inventions over time.

Determining a rating may also include determining a confidence score in a rating, representing how accurate the rating is likely to be. In a further embodiment, the refining steps 206 or 208 may repeat continuously or iteratively until a threshold confidence score is reached in a threshold number of ratings.

Rating may include determining abstract scores, concrete ratings, or rankings of prior art. As an example of an abstract score, a “match score” determined by an artificial network, on a 1000-point scale. A concrete rating may include a percentage likelihood that the prior art reference is relevant, a ratio of the number of keywords from a list of invention keywords found at 202 that are present in the prior art reference to the total number of keywords, or a confidence rating in the likelihood that the prior art reference discloses a key limitation of the invention. A ranking may be based on one or more scores, from high to low or from low to high, or by any of the methods described above. For example, a particle swarm optimization algorithm may provide a ranking of the highest peaks of relevance, built as a mapping is traversed, where tied references are listed arbitrarily or in the order in which they are traversed.

The novelty checking program 150 may identify one or more ratings for each reference, such as a relevance rating, a keyword match rating, and a ranking or a relevance rating for each key limitation of the invention. The novelty checking program 150 may also determine ratings for a set of references, such as references relating to a given topic, or an overall rating for the entire set of search results, according to any of the above methods, or any method for averaging, compiling, or composing other ratings. Set or overall ratings may be used, for example, to determine whether or not to continue refining the search space. As a more specific example, if an overall confidence rating in the current search result is 59%, and another round of refining leads to an increase in the confidence rating to 62%, the novelty checking program 150 may determine whether to continue based on whether the 3% increase in confidence is worth the time and computing cost of repeated refining.

Ratings may be set or modified over time or changed at any point throughout the process for assessing novelty using various techniques 200.

Then, at 212, the novelty checking program 150 assesses the novelty of the invention. Assessing novelty may involve be a Boolean determination, or a more complex task such as preparing a novelty report. Novelty may be assessed based on a checking of limitations, a general checking of ratings found at 210, by an algorithmic process, by a human informed by the rated prior art at 210, or by any combination thereof. Assessing novelty may further include making a recommendation or performing an action based on the assessment of novelty.

Assessing novelty may be a binary or Boolean determination, or a more complex determination. A binary or Boolean assessment may be to determine if an invention is or is not novel, or to determine whether an invention is or is not worth pursuing. A more complex assessment may include preparing an explanation or report about the novelty. A report may contain a listing of prior art references and a description of their proposed relevance where, for example, the description is generated with use of a trained Large Language Model, or by a human user, all followed by an overall novelty score. As another alternative, a complex assessment may include highlighting the potentially novel portions of a sample claim or search claim generated at 202, or showing a likelihood that each limitation in the sample claim or search claim is novel. As another alternative, the novelty checking program 150 may generate a simplified invention score or rating based on a novelty score and business value score, wherein the invention score represents a degree of priority for filing the invention soon, or internationally.

Novelty may be assessed based on a checking of limitations. For example, the novelty checking program 150 may check the novelty of each limitation in a set of limitations identified at 202 against each piece of prior art with a match score of 60% or higher, and prepare a short report addressing the novelty of each claim.

Alternatively, novelty may be assessed based on a general checking of ratings found at 210. For example, if an invention relates to two topics, and does not have any matches above 60% in one of the two topics, the novelty checking program 150 may conclude that there is likely to be a novel feature around that topic.

Novelty may be assessed by a more complex algorithmic process, including a process of NLP, AI, use of trained machine learning models, calculations based on ratings or other metadata, or any combination of these techniques. For example, the novelty checking program 150 may utilize a variety of AI techniques, where slower, more accurate AI techniques are used to process references with higher match ratings and less accurate AI techniques are used to process references with lower match ratings, and where each technique provides relevant features found in the prior art to be processed by an NLP algorithm. Assessing novelty may further be performed by providing the prior art ratings to another program, such as a dedicated program for automatically generating prior art search reports.

Alternatively, novelty may be assessed by a human. The novelty checking program 150 may present a human with the prior art ratings found at 210, or with prompts or questions based on the prior art ratings found at 210, or with a list of prior art ordered according to a ranking found at 210.

Novelty may be assessed using any combination of the above techniques. For example, a human may be provided with search results that offer filters based on variable score thresholds and highlight the most relevant text found in each reference as determined by NLP.

Assessing novelty may further include making a recommendation or performing an action based on the assessment of novelty. For example, assessing novelty may include recommending a change in or feature for the invention that was not found in the prior art, or which may help to distinguish the invention from the prior art. Alternatively, upon assessing that an invention is novel, assessing novelty may include repeating the assessment to determine business value, or sending a communication (such as an email, message, or notification) to an invention professional responsible for the invention.

In alternate embodiments, the novelty checking program 150 may assess other features, such as a business value, such as a strategic value, licensing value, or international value of the invention, or any combination of one or more features, including an assessment of novelty and an assessment of another feature. For example, if a human user identifies a novel claim in advance, the novelty checking program may rate prior art for relevance and similarity to the novel claim, and assess value of the novel claim, either compared to valuations of prior art references (either determined by the novelty checking program 150 or obtained from an external source), or based on the degree of similarity or the extent to which the invention can be “designed around” based on patterns in the prior art.

It may be appreciated that FIG. 2 provides only an illustration of one implementation and does not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
identifying information describing an invention;
defining a search space of prior art;
refining the search space based on a comparison between the invention and the prior art using natural language processing, and further based on a heuristic algorithm;
determining a rating of a reference found in the refined search space; and
assessing a novelty of the invention based on the rating.

2. The method of claim 1, wherein the heuristic algorithm is a particle swarm optimization algorithm.

3. The method of claim 1, wherein the natural language processing includes topic modeling.

4. The method of claim 1, wherein assessing novelty includes preparing a novelty report explaining the assessment of the novelty, wherein the preparing is performed by a trained large language model.

5. The method of claim 1, wherein the assessing further includes assessing a business value of the invention.

6. The method of claim 1, further comprising:
recommending a change in the invention based on the rating.

7. The method of claim 1, wherein defining the search space includes using a Gaussian mixture model to define one or more clusters in the search space.

8. A computer system, the computer system comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
identifying information describing an invention;
defining a search space of prior art;
refining the search space based on a comparison between the invention and the prior art using natural language processing, and further based on a heuristic algorithm;
determining a rating of a reference found in the refined search space; and
assessing a novelty of the invention based on the rating.

9. The computer system of claim 8, wherein the heuristic algorithm is a particle swarm optimization algorithm.

10. The computer system of claim 8, wherein the natural language processing includes topic modeling.

11. The computer system of claim 8, wherein assessing novelty includes preparing a novelty report explaining the assessment of the novelty, wherein the preparing is performed by a trained large language model.

12. The computer system of claim 8, wherein the feature is a target feature, and wherein drawing a conclusion includes determining a projected value of the target feature with respect to a data point where the value of the target feature is unknown.

13. The computer system of claim 8, further comprising:
recommending a change in the invention based on the rating.

14. The computer system of claim 8, wherein defining the search space includes using a Gaussian mixture model to define one or more clusters in the search space.

15. A computer program product, the computer program product comprising:
one or more computer-readable tangible storage media and program instructions stored on at least one of the one or more tangible storage media, the program instructions executable by a processor capable of performing a method, the method comprising:
identifying information describing an invention;
defining a search space of prior art;
refining the search space based on a comparison between the invention and the prior art using natural language processing, and further based on a heuristic algorithm;
determining a rating of a reference found in the refined search space; and
assessing a novelty of the invention based on the rating.

16. The computer program product of claim 15, wherein the heuristic algorithm is a particle swarm optimization algorithm.

17. The computer program product of claim 15, wherein the natural language processing includes topic modeling.

18. The computer program product of claim 15, wherein assessing novelty includes preparing a novelty report explaining the assessment of the novelty, wherein the preparing is performed by a trained large language model.

19. The computer program product of claim 15, wherein the feature is a target feature, and wherein drawing a conclusion includes determining a projected value of the target feature with respect to a data point where the value of the target feature is unknown.

20. The computer program product of claim 15, further comprising:
recommending a change in the invention based on the rating.
